(19) United States
(12) Patent Application Publication
(10) Pub. No.: US 2011/0065386 A1
(43) Pub. Date: Mar. 17, 2011

(54) CHIP CARD HAVING TRANSMITTING AND RECEIVING DEVICE, AND ANTENNA FOR RADIO TRANSMISSIONS

(76) Inventor: Walter Keller, Ratingen (DE)

(21) Appl. No.: 12/922,321

(22) PCT Filed: Jan. 26, 2009
(86) PCT No.: PCT/EP09/00472

§ 371 Date: Oct. 1, 2010

(30) Foreign Application Priority Data
Apr. 14, 2008 (DE) 10 2008 018 896.4

(51) Int. Cl. H04B 5/00

(52) U.S. Cl. 455/41.1

(57) ABSTRACT

The invention relates to a SIM card (21) or chip card (20), particularly for authenticating at least one mobile terminal, wherein the SIM card (21) comprises at least one processor (1) and contact areas (22) for connecting the SIM card (21) to a mobile terminal, wherein the SIM card (21) comprises an antenna (15, 23) or comprises further contact areas (14, 24) for connecting to an antenna (15, 23), and that the SIM card (21) comprises a radio interface (200) for establishing and maintaining a short-range radio connection.

The invention relates to a SIM card or chip card, in particular for authentication of at least one mobile terminal, the SIM card being provided with at least one processor and contacts for connecting the SIM card with a mobile terminal.

A SIM (Subscriber Identity Module) card is a chip card that is installed in a mobile terminal such as a mobile telephone and serves to identify the user in the mobile radio-communication network, i.e. for authentication of a mobile terminal. Usually, the SIM card has a processor with a memory. The SIM card associates the mobile terminal, i.e. in particular, a mobile telephone with a user and this user is authenticated. For these purposes, corresponding identifications, numbers and algorithms are stored in the SIM card.

Energy is supplied to the SIM card from the mobile terminal into which the SIM card is placed or installed.

In addition, various payment methods that use chip cards are known. Today, chip cards are used for noncash payments, among other things. These are plastic cards in a credit-card format (typically 85×55 mm) with incorporated electronic circuits with or without magnetic strips, as well as with or without electronic contacts that are read by a suitable reader at the point of sale (POS).

Beyond that, chip cards with additional uses for subscriber authentication such as, for example, storing subscriber telephone numbers, etc. are used as SIM (Subscriber Identification Module) in radio-communication terminals. As a rule, these cards are supplied in a credit-card format and have a preembossed smaller chip card with dimensions of 25×15 mm, that can easily be broken out of the full format card by means of predetermined fracture points, and can be used in a small mobile terminal. Beyond that, there are SIM adapters for the personal computer (PC) that can optionally be connected by a universal serial bus (USB), FireWire, or PC card and thus enable reading and writing the SIM memory, as well as the use of a PC as mobile radio terminal possible.

Different payment methods using a mobile terminal connected to a radio-communication network are described as mobile payment. There are also variants in which the SIM card or in general a chip card (stored value card) functions as prepaid card and administers a prepaid sum of money that, for example, makes payment possible at automatic machines (for example ticket machines) that are specially equipped therefor.

Previous payment solutions that have a communication link between a mobile radio terminal (cell phone) and, for example, an automatic machine, require a specially designed cell phone with a transmitter and receiver, for example, Bluetooth, RFIT-NFC (Near-Field Communication according to ECMA 340 or NFCIP1 Near-Field Communication Interface and Protocol according to ISO/IEC 18092), wireless Ethernet (WiFi), or wireless local area network (WLAN), etc.

The current standardization of, for example Bluetooth, WiFi and WLAN require a significant configuration effort to establish a secure connection between two devices and as a rule, do not provide the required protection against misuse that would be required for an automatic connection at the POS between, for example, an electronic cash register system and a mobile radio-communication terminal. On the other hand, such interfaces are located primarily in the currently most expensive multimedia terminals, where they are used for the transmission of audio and video data, as well as for connecting hands-free equipment.

It is particularly disadvantageous that it is not possible to retrofit available terminals with such interfaces.

RFIT is provided for connections between a reader and a label and serves to read data. On this basis, a secure communication between different devices is not provided. The proposed near-field radio system NFC, on the other hand, is intended to make communication between devices possible, in particular also payment processes and is based on the radio communication of the RFIT specification, and uses, however, different transmission protocols and methods for establishing secure connections between different devices.

The NFC method works in the range of 13.56 MHZ at a distance between the devices of a maximum of 20 centimeters, and transmits at a maximum up to 424 Kbit/s, or according to the expansion of the standards (ISO/IEC 18092, ECMA 340, ETSI TS 102 190) up to 1 Mbit/sec.

The disadvantage of the procedural approach of the NFC is the requirement of a special end-user device. For application of this method, a specially equipped or retrofitted terminal is required.

It is the object of the invention to provide a system with which different mobile radio terminals can be equipped with a transmitter and receiver optimized for short ranges as simply and economically as possible, in particular for the execution of payment processes.

This problem is solved in accordance with the invention by a SIM card according to claim 1 and a method according to claim 12. Further advantageous embodiments of the invention are indicated in the dependent claims.

It is particularly advantageous in the SIM card or chip card in accordance with the invention, in particular for authentication of at least one mobile radio terminal, that the SIM card is provided with at least one processor and contacts for connecting the SIM card with a mobile radio terminal, that the SIM card has an antenna or additional contacts for connection with an antenna, and that the SIM card is provided with a radio interface for establishing and maintaining a near-field radio connection.

Thus, in accordance with the invention a SIM card is equipped with a transmitter and receiver as well as an antenna for radio transmissions, or with contact positions for connection with an antenna for radio transmission, so that by means of the SIM card, without using the mobile radio network, a near-field radio communication connection can be established and maintained, in order to utilize additional services independent of the mobile radio network. For example, payment processes can be processed with a near-field radio communication connection of this type.

Preferably, the antenna is flat and mounted on the underside of the SIM card. As a result of this location it is possible, in an advantageous manner, to integrate the antenna into the SIM card for establishing and maintaining a radio connection without having to change the geometric general conditions of the SIM card, i.e. the SIM card in accordance with the invention can correspond to the standard format.

In a preferred embodiment, the radio interface is established by a signal processor integrated into the SIM card.

Preferably, the radio interface is provided with an analog/digital converter and digital/analog converter.

In a preferred embodiment, the radio interface is provided with a digital filter.

Preferably, the radio interface has an input and/or output amplifier.

When an analog digital converter and a digital analog converter and/or a digital filter and/or an input and/or output amplifier is provided, the radio interface in accordance with the invention can be adapted to various requirements in order to establish and maintain a radio connection with suitable remote stations.

In a particularly preferred embodiment, the radio interface and the processor of the SIM card are integrated into an electronic component, i.e. the processor of a SIM card known previously, as well as the radio interface of the SIM card provided in accordance with the invention, can be integrated in a single integrated chip of the card.

In an authentication method according to the invention it is particularly advantageous that the SIM card of a mobile radio terminal is in radio connection with one or more readers and serves to authenticate the mobile radio device(s) by means of a radio interface of a near-field communicator integrated in the SIM card.

The solution in accordance with the invention is based on integrating in a chip card a complete transmitting and receiving unit forming a radio interface including antenna optimized for short ranges at the POS, preferably the SIM, and to make it available as module that can be retrofitted for mobile terminals, for example MS for the cellular GSM or the UMTS network, as a result of which the necessity for the purchase of specific terminals that are equipped with corresponding hardware is eliminated.

In the following text, the term payment radio link (PRL) means the wireless transmission method between a mobile terminal and a POS and only by way of example. PRL thus contains the technical equipment for wireless transmission of data (language optional) for, as a rule, short ranges (transmitting and receiving amplifier, modulator, demodulator, analog to digital converter and the reverse, if needed echo compensation method, intermediate storage, antenna, etc.), that lies—specific to the application—in the decimeter or meter range, as well as the logical prerequisites for establishing (negotiating) a secure connection between two devices, as well as the corresponding transmission protocols for the secure execution of the required data transmission and for the deterministic disconnection of the connection.

In this sense, a PRL can be based on an NFC transmission method, however, also any other method of the previously mentioned functionality. The invention does not deal with the transmission process itself, but describes a technical functionality and its integration into a radio-communication terminal in such a way that as large a number as possible of available and new terminals can participate in new and innovative services by means of a method that is as economical as possible due to technology, for example, a new noncash payment process at the POS.

Without question, the new method, for example, also with PRL functionality, can be integrated into a new cell phone by adding electronic components and software programs. In accordance with the invention it is assumed, however, that the customer could subsequently retrofit an existing cell phone with such functionality, or a radio communication provider can equip different end-user devices with this technology without any new design work.

In such cases, the SIM is suggested as the location for integration, because such a module is used by the most widely used cellular GSM and UMTS radio-communication networks in each terminal and can be changed easily.

When integrating an antenna onto a SIM, a reduced range and shielding effect of the terminal itself (the SIM is, as a rule, located within the cell phone) must be expected, which does not play any role, however, in the required short radio range for this application. However, the invention leaves room for applications with a need for a larger range by creating a possibility of mounting an antenna outside to the SIM. An automated machine that is located inaccessibly can profit from this, for example. For connection with an externally mounted antenna, corresponding contacts are provided.

An example of an embodiment of the invention is shown in the figures and is explained in the following. Therein:

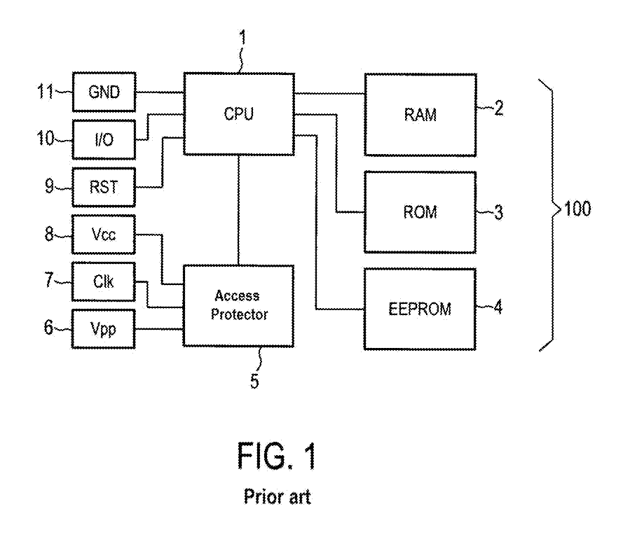

FIG. 1 is a schematic diagram of a SIM card according to prior art;

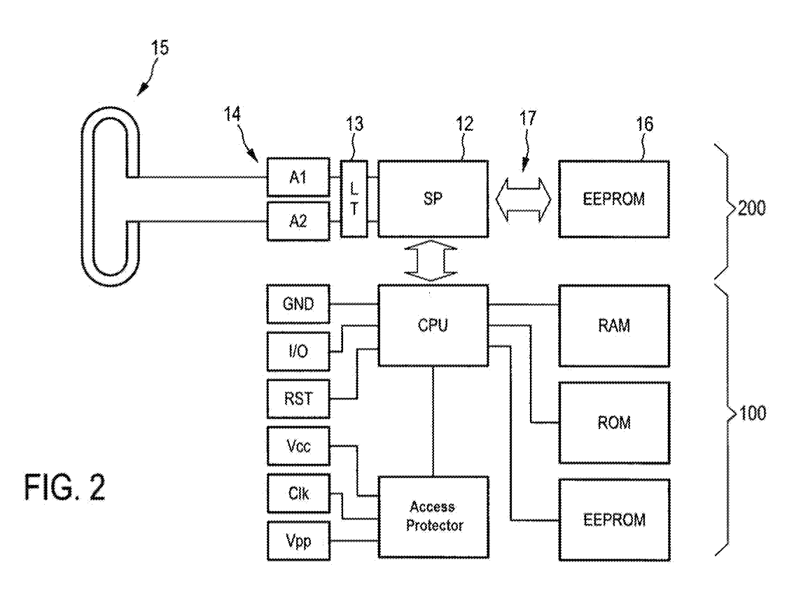

FIG. 2 is a schematic diagram of a SIM card in accordance with the invention;

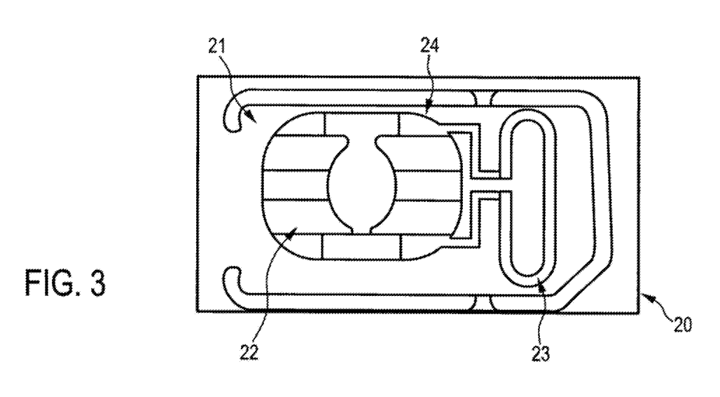

FIG. 3 is a view of a chip card with integrated transceiver;

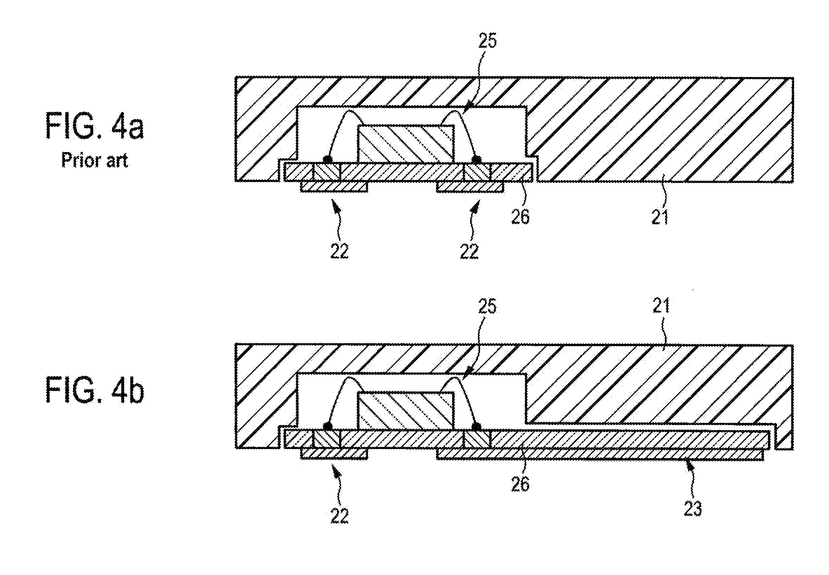

FIG. 4a is a cross section through a SIM card according to the prior art;

FIG. 4b is a cross section through a SIM card according to the invention with integrated antenna.

Identical components or modules are labeled with identical reference numbers in the figures and are used accordingly in the following.

A conventional SIM is schematically shown in FIG. 1. It has a complete microprocessor circuit 100, i.e. a microprocessor 1 with a RAM memory 2 and can be designed for intelligent additional services. Thus, for example, telephone numbers can be stored in the memory 2. New SIM cards are also provided with large memories 2, for example, for audio or video data. The different functional blocks are, as a rule, provided in a single electronic component (chip).

Further, the operating system of the SIM is stored in a read-only memory 3 (ROM) and the application data are stored in an EEPROM 4. The SIM card has a security device 5 for access protection, as well as various contacts such for a programmed voltage 6 (Vpp), clock signal 7 (ClK), voltage supply 8 (Vcc), reset 9 (RST, reset), input/output 10 (I/O) and ground 11 (GND).

Thus, FIG. 1 schematically shows a conventional SIM card.

In accordance with the invention, the SIM is expanded with PRL functionality. This is shown schematically in FIG. 2. FIG. 2 shows a SIM card in accordance with the invention comprising the conventional chip card architecture 100 of FIG. 1, but expanded according to the invention by a radio interface 200. The radio interface 200 has a signal processor 12 (SP), a specifically associated program and data memory 16 (EEPROM), a line driver (transmitting/receiving amplifier) 13 (LT), as well as contacts 14 (A1, A2) to antenna 15.

The SIM connection allocation as interface, for example, to the terminal remains physically unchanged, so that it can be used in preexisting terminals. The SIM is complemented with an additional signal processor functionality downstream of the SIM processor or preferably as integrated expansion of the SIM chip, which processes, by working together with the microprocessor of the SIM, the radio interface protocol process, as well as the required analog amplifier and filter functions, the analog/digital conversion, as well as in reverse, the digital analog conversion, the modem functionality, as well as the input and output amplification and decouples the transmitted and received signals by, for example, an echo compensation process.

The signal processor 12 has its own program and data storage 16 that is connected by a specific interface 17, and relieves the SIM processor 100 from time-critical processing processes of the PRL functionality such as, for example, transmitting and receiving tasks, modulation and demodulation, coding processes, error compensation, etc. These functions can be initiated and controlled by the SIM processor and processed autonomously in signal processor 200.

The program memory of the signal processor can be loaded, in accordance with the invention, with the support of the SIM processor via the radio-communication network by a server, in order to correct potential programming errors and to make program optimizations, as well as new PRL functionalities available.

The antenna 15 is preferably also located on the SIM module. In an advantageous variant, the complete circuits including the signal processor and driver circuit are integrated in a single component (chip) on the SIM.

The antenna 15 can optionally be previously provided in the device, in which case it is connected with the SIM by a contact array that is expanded by functionality A1 and A2. In this variant, transmitting/receiving amplifiers 13 can optionally be located in the terminal device for optimal high frequency transmission. Such a process requires a new end-user device (or optionally a SIM adapter) and makes, for example, sense when using a SIM connected to a PC-controlled electronic cash register, when the range of several cash registers is to be included. In this case, the SIM can include an additional antenna, for example, in a SIM adapter, that in turn is installed at an exposed location in the electronic cash register area, and is, for example, connected with the cash register PC by means of an Ethernet or USB connection.

The SIM antenna 15 or 23 can be advantageously attached by pressure or galvanically to the underside of the SIM (contact side), as shown in FIG. 4b. In this procedural approach, the electronic component has, beyond the scope of the conventional connections, two additional contact surfaces (A1 and A2).

The arrangement of the SIM antenna on the SIM contact surface (underside) is particularly advantageous and permits in particular, the simultaneous manufacture of contact surfaces and antenna in one single work step.

In the event of sufficient material strength or mechanical stability of the printed-circuit contacts, the galvanic through-contacting by a chip support 26 can be dispensed with. In this case, wire contacts 25 are connected (bonded) directly with the SIM antenna and the SIM contact surfaces at corresponding cutouts of the chip support.

FIG. 3 shows, for example, the arrangement of an antenna 23 on the contact side of a SIM 21 with, for example, six contacts 22 for contact springs in the terminal, the SIM 21 being shown as cut out of a chip card 20 (conventional credit-card format). For the antenna connection, additional contacts 24 are used that are not connected with the terminal by means of contact springs 22.

FIG. 4 schematically shows a preferred mechanical design of the SIM. The zones of the contact field 22 used for the connection of antenna 23 are not used for the spring contacts of the SIM retainer and serve, in accordance with the invention, to implement the antenna connections by means of the chip support 26 and are co-manufactured with respect to it in the same work steps as the through contacts of the SIM contact fields 22. In contrast to the conventional SIM according to FIG. 4a, variant b according to FIG. 4b continues to preferably have an antenna 23 attached galvanically together with the contacts to the chip support 26 that is specially enlarged for this. The actual chip is usually applied by means of soldering, adhesion or bonding technology (shown is a wire bonding technique). According to FIG. 3, the outer contact surfaces 24 can be used for antenna contacting, for example.

FIG. 4 schematically shows in the lateral view of FIG. 4a (top), the connection of the two contact fields 22 through the chip support 26, and by means of bonding wire to the SIM chip. In FIG. 4b (bottom), the connection of the antenna 23 (right side) that is attached on the contact side, as well as the example of a contact field 22 (left side) is shown in a side view. Chip and wiring 25 are integrated into a card housing 21 provided with contacts 22 and antenna 23 on its underside.

This method in accordance with the invention also makes the economical and simple retrofitting of a POS with PRL functionality possible. To this end, the SIM is connected to the PC, or to the processor-controlled electronic cash register or to an automated machine by using a conventional SIM adapter in USB, FireWire, PC card or similar procedure, or is installed in a corresponding socket of the PC (electronic cash register or automated machine), a commercial SIM adapter being usable.

Thus, in accordance with the invention a chip card is equipped with a transmitter and receiver, as well as with an antenna for radio transmission, so that a chip card, for example, a mobile radio network subscriber identification module (SIM) is equipped for processing noncash payment services with an antenna and all circuit and program-controlled components such as, for example, a signal processor, a protocol control (program-controlled microprocessor), analog amplifier elements, digital/analog and analog/digital converters, etc. that are required for wireless transmission of data (language optional) over an, as a rule, short range, in the range of preferably decimeters or meters, in order to establish a secure connection between the mobile radio terminal and the point of sale that is fully automated after being initiated by the user, perform corresponding transmission protocols securely and to subsequently terminate the existing connection deterministically, the SIM preferably containing the required electronic components in a single electronic circuit (chip), as well as also the antenna in, for example, a form that is printed on or produced galvanically within the SIM or optionally on at least one of its outer faces.

This functionality of a POS radio connection (Payment Radio Link—PRL) is made available in the terminal device by the simple exchange of a conventional SIM with a SIM in accordance with the invention without any additional hardware steps, the additionally required operating software for controlling the expanded SIM, as well as the processing of payment services (menu control) internal to the device and the optionally additionally connected communication [link] with financial services devices that are internal to the mobile communication network or connected to the mobile communication network (for example, server units) of the terminal device being installed in the terminal additionally by, for example, the exchange of the terminal device program memory or by download from a specific server unit. This functionality also includes the program exchange for the PRL signal processor for the flexible adaptation to radio communication changes of the PRL radio interface.

The SIM antenna for the PRL can preferably (for example galvanically) be produced jointly on the contact side of the SIM in the same work step with the contact (FIG. 4) and be located on a chip support that is enlarged for this case, the connection of the antenna with the SIM chip being established in the same way by wire bonding or adhesion, or soldering, as the SIM chip contact and the connections of the antenna on the contact side of the SIM are executed likewise by the chip support, as they are for the SIM connection contact, which can also take place by means of this manufacturing process with the same process steps as the through contact of the chip contacts. The goal of this procedural approach is cost optimization of the manufacturing processes for the attachment of the additional antenna on the SIM module.

It is possible that the PRL chip card can be used several times and, for example, can be connected by means of a plug or a SIM adapter with, for example, USB, FireWire Ethernet or PC card interface to a processor-controlled POS, for example, an electronic cash register device, a POS central processor or an automated machine, etc., whereby additional software related to the PRL chip card takes over the control of the PRL chip card. In this application, the process control of the PRL chip card is organized in such a way that advantage can also be taken even of pure PRL functionality without mobile radio operation. Due to this, the module is universally usable. The authentication and encryption procedures that are typical in the mobile radio sector are not used in such applications and are switched off by a control command that is communicated to the SIM through a device connection.

An antenna mounted on the outside of the PRL chip card can be operated optionally through the contact of the antenna connection contacts of the module (in the terminal or, for example, a PC adapter) and as a result, an improved range and transmission quality of the module can be achieved, so that in this type of operation in turn optionally, the transmission and receiving amplifiers are mounted on the outer surface of the PRL chip card in the end-user device or, for example, on an adapter. In this case, an expanded SIM socket with additional contacts for fields A1 and A2 is required. The procedural approach is suitable for a stationary POS operation and, for example, special end-user devices (PCs, notebooks and special end-user devices, for example, for handicapped persons who require a bigger radio range).

It is also possible to integrate the SIM card as well the antenna in a plastic support or into a plastic card, chip card or the like.

Within the meaning of the invention, the term SIM card is to be understood as covering any subscriber identity module such as SIM or USIM or the like, in particular also any other form of chip card such as, for example, chip cards integrated on check cards or the like that are provided with a processor and contacts for connection with a device. The radio interface in accordance with the invention, as well as antenna contacts or an antenna can be integrated even in chip cards of this type.

1-12. (canceled)

13. A SIM chip card for authentication of at least one mobile terminal device, the SIM card having
at least one processor and contacts for connecting the SIM card with a mobile radio terminal device;
with an antenna or additional contacts for connection with an antenna; and
a radio interface for establishing and maintaining a near-field radio connection, the radio interface and a processor of the SIM card being integrated into an electronic component.

14. The SIM card according to claim 13, wherein the antenna is flat and mounted on the underside of the SIM card.

15. The SIM card according to claim 13, wherein radio interface is formed by a signal processor integrated into the SIM card.

16. The SIM card according to claim 13, wherein the radio interface is provided with an analog/digital converter and a digital/analog converter.

17. The SIM card according to claim 13, wherein the radio interface is provided with a digital filter.

18. The SIM card according to claim 13, wherein the radio interface is provided with an input or an output amplifier.

19. The SIM card according to claim 13, wherein the signal processor has its own program and data memory.

20. The SIM card according to claim 19, wherein the signal processor can execute its own storing transactions, calculating processes and programming steps independent of the SIM processor and its memory devices.

21. The SIM card according to claim 19, wherein the program memory or data memory of the signal processor can be changed, loaded or subsequently loaded with the help of the SIM processor via the mobile radio network or an interface to a server unit, a PC or a network connected to the mobile radio terminal.

22. The SIM card according to claim 19, wherein the program memory or data memory of the signal processor can be changed, loaded, or reloaded via the PRL wireless interface.

23. An authentication method in which the SIM card of a mobile radio terminal device is in radio communication by means of radio interface integrated into the SIM card in a near-field communication with one or more readers and serves to authenticate the mobile radio terminal.
